(19) United States
(12) Patent Application Publication
(10) Pub. No.: US 2024/0244624 A1
(43) Pub. Date: Jul. 18, 2024

(54) Devices and Methods for Semi-Static Pattern Configuration for PUCCH Carrier Switching

(71) Applicant: Telefonaktiebolaget LM Ericsson (PUBL), Stockholm (SE)

(72) Inventors: Kittipong Kittichokechai, JÄRFÄLLA (SE); Mattias Andersson, SUNDBYBERG (SE); Sorour Falahati, STOCKHOLM (SE); Bikramjit Singh, KIRKKONUMMI (FI); Yufei Blankenship, KILDEER, IL (US); Yufeng Zhao, UPPLANDS VÄSBY (SE)

(21) Appl. No.: 18/559,846

(22) PCT Filed: May 11, 2022
(86) PCT No.: PCT/IB2022/054410

§ 371 Date: Nov. 9, 2023

Related U.S. Application Data
(60) Provisional application No. 63/187,378, filed on May 11, 2021.

(51) Int. Cl. H04W 72/21; H04L 1/1812; H04W 72/0446; H04W 72/1273

(52) U.S. Cl. CPC H04W 72/21; H04L 1/1812; H04W 72/0446; H04W 72/1273

(57) ABSTRACT

User equipments, network nodes, and systems are described to transmitting and receiving a physical uplink control channel, PUCCH. For example, a user equipment may receive configuration information from a network node. The configuration information may indicate a plurality of cells available for transmitting or for receiving the PUCCH, the plurality of cells including a reference cell and may indicate a plurality of cell index values respectively associated with a plurality of slots of the reference cell, each cell index value indicating a respective designated cell from among the plurality of cell. The user equipment may receive a timing indicator indicating a reference slot from among the plurality of slots of the reference cell and may transmit the PUCCH using the respective designated cell indicated by the cell index value associated with the reference slot.

### RELATED APPLICATIONS

This application claims the benefit of U.S. Provisional Patent App. No. 63/187,378, filed May 11, 2021, the disclosure of which is hereby incorporated herein by reference in its entirety.

### TECHNICAL FIELD

The present disclosure relates to transmission of control information in a cellular communications network.

### BACKGROUND

New radio (NR) standard in 3GPP is designed to provide service for multiple use cases such as enhanced mobile broadband (eMBB), ultra-reliable and low latency communication (URLLC), and machine type communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot is a concept that is used in scheduling and in DL a min-slot can include 2, 4 or 7 OFDM symbols, while in UL a mini-slot can be any number of 1 to 14 OFDM symbols. It should be noted that the concepts of slot and mini-slot are not specific to a specific service meaning that a mini-slot may be used for either eMBB, URLLC, or other services. FIG. 1 illustrates an example of a radio resource in NR.

### Downlink Control Information

In 3GPP NR standard, downlink control information (DCI) which is transmitted in physical downlink control channel (PDCCH), is used to indicate the DL data related information, UL related information, power control information, slot format indication, etc. There are different formats of DCI associated with each of these control signals and the UE identifies them based on different radio network temporary identifiers (RNTIs).

A UE is configured by higher layer signaling to monitor for DCIs in different resources with different periodicities, etc. DCI formats 1_0, 1_1, and 1_2 are used for scheduling DL data which is sent in physical downlink shard channel (PDSCH), and includes time and frequency resources for DL transmission, as well as modulation and coding information, HARQ (hybrid automatic repeat request) information, etc.

In case of DL semi-persistent scheduling (SPS) and UL configured grant type 2, part of the scheduling including the periodicity is provided by the higher layer configurations, while the rest of scheduling information such as time domain and frequency domain resource allocation, modulation and coding, etc., are provided by the DCI in PDCCH

### Uplink Control Information

Uplink control information (UCI) is a control information sent by a UE to a gNB. It includes:
Hybrid-ARQ acknowledgement (HARQ-ACK) which is a feedback information corresponding to the received downlink transport block whether the transport block reception is successful or not,
Channel state information (CSI) related to downlink channel conditions which provides gNB with channel-related information useful for DL scheduling, including information for multi-antenna and beamforming schemes, and
Scheduling request (SR) which indicates a need of UL resources for UL data transmission

UCI is typically transmitted on physical uplink control channel (PUCCH). However, if a UE is transmitting data on the PUSCH with a valid PUSCH resource overlapping with PUCCH, UCI can be multiplexed with UL data and transmitted on PUSCH instead, if the timeline requirements for UCI multiplexing is met

### Physical Uplink Control Channel

Physical Uplink Control Channel (PUCCH) is used by a UE to transmit HARQ-ACK feedback message corresponding to the reception of DL data transmission. It is also used by the UE to send channel state information (CSI) or to request for an uplink grant for transmitting UL data.

In NR, there exist multiple PUCCH formats supporting different UCI payload sizes. PUCCH formats 0 and 1 support UCI up to 2 bits, while PUCCH formats 2, 3, and 4 can support UCI of more than 2 bits. In terms of PUCCH transmission duration, PUCCH formats 0 and 2 are considered short PUCCH formats supporting PUCCH duration of 1 or 2 OFDM symbols, while PUCCH formats 1,3, and 4 are considered as long formats and can support PUCCH duration from 4 to 14 symbols.

### HARQ Feedback

The procedure for receiving downlink transmission is that the UE first monitors and decodes a PDDCH in slot n which points to a DL data scheduled in slot n+K₀ slots (K₀ is larger than or equal to 0). The UE then decodes the data in the corresponding PDSCH. Finally based on the outcome of the decoding the UE sends an acknowledgement of the correct decoding (ACK) or a negative acknowledgement (NACK) to the gNB at time slot n+K₀+K₁ (in case of slot aggregation n+K₀ would be replaced by the slot where PDSCH ends). Both of K₀ and K₁ are indicated in the DCI. The resources for sending the acknowledgement are indicated by PUCCH resource indicator (PRI) field in the DCI which points to one of PUCCH resources that are configured by higher layers.

Depending on DL/UL slot configurations, or whether carrier aggregation, or per code-block group (CBG) transmission used in the DL, the feedback for several PDSCHs may need to be multiplexed in one feedback. This is done by constructing HARQ-ACK codebooks. In NR, the UE can be configured to multiplex the A/N bits using a semi-static codebook or a dynamic codebook.

Type 1 or semi-static codebook includes a bit sequence where each element contains the A/N bit from a possible allocation in a certain slot, carrier, or transport block (TB). When the UE is configured with CBG and/or time-domain resource allocation (TDRA) table with multiple entries, multiple bits are generated per slot and TB (see below). It is important to note that the codebook is derived regardless of the actual PDSCH scheduling. The size and format of the semi-static codebook is preconfigured based on the mentioned parameters. The drawback of semi-static HARQ ACK codebook is that the size is fixed, and regardless of whether there is a transmission or not a bit is reserved in the feedback matrix.

On the case when a UE has a TDRA table with multiple time-domain resource allocation entries configured: The table is pruned (i.e. entries are removed based on a specified algorithm) to derive a TDRA table that only contains non-overlapping time-domain allocations. One bit is then reserved in the HARQ CB for each non-overlapping entry (assuming a UE is capable of supporting reception of multiple PDSCH in a slot).

To avoid reserving unnecessary bits in a semi-static HARQ codebook, in NR a UE can be configured to use a type 2 or dynamic HARQ codebook, where an A/N bit is present only if there is a corresponding transmission scheduled. To avoid any confusion between the gNB and the UE, on the number of PDSCHs that the UE has to send a feedback for, a counter downlink assignment indicator (DAI) field exists in DL assignment, which denotes accumulative number of {serving cell, PDCCH occasion} pairs in which a PDSCH is scheduled to a UE up to the current PDCCH. In addition to that, there is another field called total DAI, which when present shows the total number of {serving cell, PDCCH occasion} up to (and including) all PDCCHs of the current PDCCH monitoring occasion. The timing for sending HARQ feedback is determined based on both PDSCH transmission slot with reference to PDCCH slot (K₀) and the PUCCH slot that contains HARQ feedback (K₁).

FIG. 2 illustrates the timeline in a simple scenario with two PDSCHs and one feedback occasion. In this example, there is in total 4 PUCCH resources configured, and the PRI indicates PUCCH 2 to be used for HARQ feedback. We explain in the following how PUCCH 2 is selected from 4 PUCCH resources based on the procedure in Rel-15.

In NR Rel-15, a UE can be configured with maximum 4 PUCCH resource sets for transmission of HARQ-ACK information. Each set is associated with a range of UCI payload bits including HARQ-ACK bits. The first set is always associated to 1 or 2 HARQ-ACK bits and hence includes only PUCCH format 0 or 1 or both. The range of payload values (minimum of maximum values) for other sets, if configured, is provided by configuration except the maximum value for the last set where a default value is used, and the minimum value of the second set being 3. The first set can include maximum 32 PUCCH resources of PUCCH format 0 or 1. Other sets can include maximum 8 bits of format 2 or 3 or 4.

As described previously, the UE determines a slot for transmission of HARQ-ACK bits in a PUCCH corresponding to PDSCHs scheduled or activated by DCI via K₁ value provided by configuration or a field in the corresponding DCI. The UE forms a codebook from the HARQ-ACK bits with associated PUCCH in a same slot via corresponding K₁ values.

The UE determines a PUCCH resource set that the size of the codebook is within the corresponding range of payload values associated to that set.

The UE determines a PUCCH resource in that set if the set is configured with maximum 8 PUCCH resources, by a field in the last DCI associated to the corresponding PDSCHs. If the set is the first set and is configured with more than 8 resources, a PUCCH resource in that set is determined by a field in the last DCI associated to the corresponding PDSCHs and implicit rules based on the CCE.

A PUCCH resource for HARQ-ACK transmission can overlap in time with other PUCCH resources for CSI and/or SR transmissions as well as PUSCH transmissions in a slot. In case of overlapping PUCCH and/or PUSCH resources, first the UE resolves overlapping between PUCCH resources, if any, by determining a PUCCH resource carrying the total UCI (including HARQ-ACK bits) such that the UCI multiplexing timeline requirements are met. There might be partial or completely dropping of CSI bits, if any, to multiplex the UCI in the determined PUCCH resource. Then, the UE resolves overlapping between PUCCH and PUSCH resources, if any, by multiplexing the UCI on the PUSCH resource if the timeline requirements for UCI multiplexing is met.

### Cross-Carriers HARQ-ACK Feedback

In NR, when operating with carrier aggregation (CA), as a baseline, the HARQ-ACK feedback information (carried in a physical uplink control channel, PUCCH) for multiple downlink component carriers (CC) are transmitted on the primary cell (PCell). This is to support asymmetric CA with the number of downlink carriers unrelated to the number of uplink carriers.

For a large number of downlink CCs, a single uplink carrier may have to carry a large number of HARQ-ACK feedbacks. Thus, to avoid overloading a single carrier, it is possible to configure two PUCCH groups (set of serving cells) where feedbacks relating to DL transmissions in the first PUCCH group is transmitted in the uplink of the PCell within the first PUCCH group, and feedbacks relating to the DL transmissions in other PUCCH group is transmitted on the primary secondary cell (PSCell) or on a PUCCH-SCell of the second PUCCH group.

It is possible to use other UL cell for HARQ-ACK feedback transmission by semi-statically configure a serving cell ID indicating a cell within the same PUCCH group to use for the HARQ-ACK transmission. However, such configuration is only possible for a newly added SCell. That is, for DL transmission on a PCell, HARQ-ACK transmission is only possible on the PCell.

FIG. 3 shows an example of the HARQ-ACK feedback transmission mechanism with two PUCCH groups, in which the HARQ-ACK feedback for the first 4 DL CCs is transmitted in the UL PCell in the corresponding PUCCH group and the feedback for the last 3 DL CCs is transmitted in the PUCCH-SCell of the second PUCCH group.

### PUCCH Carrier Switching

Different methods for PUCCH carrier switching have been discussed during Rel-17. They may be classified into two main approaches, namely dynamic PUCCH carrier switching and semi-static switching. The dynamic approach includes having dynamic indication from the network, e.g., in the form of dedicate indication field in the DCI, while the semi-static approach may rely on some semi-static rule or semi-static configuration.

### SPS HARQ-ACK Deferral

A UE can be indicated or configured with the HARQ-ACK timing value, say K₁, for a SPS configuration. This HARQ-ACK timing value is applied to all SPS PDSCH occasions of the activated SPS configuration.

In TDD operation with asymmetric DL/UL TDD pattern, if short SPS periodicity is used, it can happen that the SPS periodicity value does not match with the TDD pattern, with respect to HARQ-ACK feedback timing. It may happen that the HARQ-ACK timing value K/does not indicate a valid UL slot for all SPS PDSCH occasions. This is illustrated in FIG. 4 with a single SPS configuration with periodicity of 1 slot where the indicated K1 does not match with the ‘DDDU’ semi-static TDD pattern. With K₁=3 slots, HARQ-ACK feedback for the second and third SPS occasions would fall into DL slots, and thus these HARQ-ACK would be dropped.

### SUMMARY

A telecommunications system of one or more devices can be configured to perform particular operations or actions by virtue of having software, firmware, hardware, or a combination of them installed on the system devices that in operation causes or cause the devices to perform the actions. One or more telecommunications devices and/or programs can be configured to perform particular operations or actions by virtue of including instructions that, when executed by processor, cause the device to perform the actions. One general aspect includes a method performed by a user equipment for transmitting a physical uplink control channel. The method includes receiving configuration information from a base station, the configuration information indicating: a plurality of cells available for transmitting or for receiving the PUCCH, the plurality of cells including a reference cell; and a plurality of cell index values respectively associated with a plurality of slots of the reference cell, each cell index value indicating a respective designated cell from among the plurality of cells. The method also includes receiving a timing indicator indicating a reference slot from among the plurality of slots of the reference cell. The method also includes transmitting the PUCCH using the respective designated cell indicated by the cell index value associated with the reference slot. Other embodiments of this aspect include corresponding computer systems, apparatus, and computer programs recorded on one or more computer storage devices, each configured to perform the actions of the methods.

Implementations may include one or more of the following features. The method where the timing indicator indicates the reference slot by indicating that the reference slot is a slot occurring a given number of slots from reception of a physical downlink shared channel. A user equipment for transmitting a physical uplink control channel, PUCCH, may include: processing circuitry configured to perform any of the steps of methods performed by the user equipment; and power supply circuitry configured to supply power to the processing circuitry. A user equipment, UE, for transmitting a physical uplink control channel, PUCCH, the UE may include: an antenna configured to send and receive wireless signals; radio front-end circuitry connected to the antenna and to processing circuitry, and configured to condition signals communicated between the antenna and the processing circuitry; the processing circuitry being configured to perform any of the steps of methods performed by the user equipment; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE. The UE may include a communication interface and processing circuitry, the communication interface and processing circuitry of the UE being configured to perform any of the steps of methods performed by the user equipment to receive the user data from the host. The cellular network further includes a network node configured to communicate with the UE to transmit the user data to the UE from the host. The processing circuitry of the host is configured to execute a host application, thereby providing the user data; and the host application is configured to interact with a client application executing on the UE, the client application being associated with the host application. The UE performs any of the steps of the described methods to receive the user data from the host. The method may include: at the host, executing a host application associated with a client application executing on the UE to receive the user data from the UE. The user data is provided by the client application in response to the input data from the host application. The UE may include a communication interface and processing circuitry, the communication interface and processing circuitry of the UE being configured to perform any of the steps of the described methods to transmit the user data to the host. The cellular network further includes a network node configured to communicate with the UE to transmit the user data from the UE to the host. The processing circuitry of the host is configured to execute a host application, thereby providing the user data; and the host application is configured to interact with a client application executing on the UE, the client application being associated with the host application. The UE performs any of the steps of the described methods to transmit the user data to the host. The method may include: at the host, executing a host application associated with a client application executing on the UE to receive the user data from the UE. The user data is provided by the client application in response to the input data from the host application. A cell index value indicates the reference cell as the respective designated cell. The method where the receiving configuration information indicating the plurality of cell index values may include dynamically receiving the configuration information indicating a cell index value. Receiving the configuration information includes the configuration information indicating a slot offset value indicating a designated slot on the designated channel during which the PUCCH is to be transmitted. The timing indicator is received over a physical downlink control channel, PDCCH. Implementations of the described techniques may include hardware, a method or process, or computer software on a computer-accessible medium.

One general aspect includes a method performed by a user equipment for transmitting physical uplink control channel. The method also includes receiving configuration information from a base station, the configuration information indicating a slot offset value associated with a reference slot of a reference cell, the slot offset value indicating a designated slot, occurring a number of slots from the reference slot. The method also includes receiving a timing indicator indicating the reference slot. The method also includes transmitting the PUCCH during the designated slot based on the slot offset value associated with the reference slot. Other embodiments of this aspect include corresponding computer systems, apparatus, and computer programs recorded on one or more computer storage devices, each configured to perform the actions of the methods.

Implementations may include one or more of the following features. The method where the slot offset value indicates that the reference cell is a designated cell. The method may include: providing user data; and forwarding the user data to a host via transmission to the network node. Implementations of the described techniques may include hardware, a method or process, or computer software on a computer-accessible medium.

One general aspect includes a method performed by a network node for receiving a physical uplink control channel. The method also includes transmitting configuration information to a user equipment, the configuration information indicating: a plurality of cells available for receiving the PUCCH, the plurality of cells including a reference cell; and a plurality of cell index values respectively associated with a plurality of slots of the reference cell, each cell index value indicating a respective designated cell from among the plurality of cells. The method also includes transmitting a timing indicator indicating a reference slot from among the plurality of slots of the reference cell. The method also includes receiving the PUCCH on the respective designated cell indicated by the cell index value associated with the reference slot. Other embodiments of this aspect include corresponding computer systems, apparatus, and computer programs recorded on one or more computer storage devices, each configured to perform the actions of the methods.

Implementations may include one or more of the following features. The method where the timing indicator indicates the reference slot by indicating that the reference slot is a slot occurring a given number of slots from transmission of a physical downlink shared channel. A cell index value indicates the reference cell as the respective designated cell. A network node for receiving a physical uplink control channel, PUCCH, the network node may include: processing circuitry configured to perform any of the steps of any of the network node's operations; and power supply circuitry configured to supply power to the processing circuitry. A host configured to operate in a communication system to provide an over-the-top (OTT) service, the host may include: processing circuitry configured to provide user data; and a network interface configured to initiate transmission of the user data to a network node in a cellular network for transmission to a user equipment, UE, the network node having a communication interface and processing circuitry, the processing circuitry of the network node configured to perform any of the network node's operations to transmit the user data from the host to the UE. The processing circuitry of the host is configured to execute a host application that provides the user data; and the UE may include processing circuitry configured to execute a client application associated with the host application to receive the transmission of user data from the host. The network node performs any of the network node's operations to transmit the user data from the host to the UE. The method may include, at the network node, transmitting the user data provided by the host for the UE. The user data is provided at the host by executing a host application that interacts with a client application executing on the UE, the client application being associated with the host application. A communication system configured to provide an over-the-top service, the communication system may include: a host may include: processing circuitry configured to provide user data for a user equipment, UE, the user data being associated with the over-the-top service; and a network interface configured to initiate transmission of the user data toward a cellular network node for transmission to the UE, the network node having a communication interface and processing circuitry, the processing circuitry of the network node configured to perform any of the network node's operations to transmit the user data from the host to the UE. The communication system may include: the network node; and/or the user equipment. A host configured to operate in a communication system to provide an over-the-top (OTT) service, the host may include: processing circuitry configured to initiate receipt of user data; and a network interface configured to receive the user data from a network node in a cellular network, the network node having a communication interface and processing circuitry, the processing circuitry of the network node configured to perform any of the network node's operations to receive the user data from a user equipment, UE, for the host. The processing circuitry of the host is configured to execute a host application, thereby providing the user data; and the host application is configured to interact with a client application executing on the UE, the client application being associated with the host application. The initiating receipt of the user data may include requesting the user data. The network node performs any of the network node's operations to receive the user data from the UE for the host. The method may include at the network node, transmitting the received user data to the host. The method where the transmitting configuration information indicating the plurality of cell index values includes dynamically transmitting the configuration information indicating a cell index value. Transmitting the configuration information includes the configuration information indicating a slot offset value indicating a designated slot on the designated channel during which the PUCCH is to be received. The timing indicator is transmitted over a physical downlink control channel, PDCCH. Implementations of the described techniques may include hardware, a method or process, or computer software on a computer-accessible medium.

One general aspect includes a method performed by a network node for receiving a physical uplink control channel. The method also includes transmitting configuration information to a user equipment, the configuration information indicating a slot offset value associated with a reference slot of a reference cell, the slot offset value indicating a designated slot, occurring a number of slots from the reference slot. The method also includes transmitting a timing indicator indicating the reference slot. The method also includes receiving the PUCCH during the designated slot based on the slot offset value associated with the reference slot. Other embodiments of this aspect include corresponding computer systems, apparatus, and computer programs recorded on one or more computer storage devices, each configured to perform the actions of the methods.

Implementations may include one or more of the following features. The method where the slot offset value indicates that the reference cell is a designated cell. The method may include: obtaining user data; and forwarding the user data to a host or a user equipment. Implementations of the described techniques may include hardware, a method or process, or computer software on a computer-accessible medium.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a radio resource in NR.

FIG. 2 illustrates a simple scenario with two PDSCHs and one feedback occasion.

FIG. 3 shows an example of the HARQ-ACK feedback transmission mechanism with two PUCCH groups.

FIG. 4 illustrates a single SPS configuration with periodicity of 1 slot where the indicated K1 does not match with the ‘DDDU’ semi-static TDD pattern.

FIG. 5 shows an example of a semi-static configuration, according to some embodiments.

FIG. 6 shows another example of a semi-static configuration, according to some embodiments.

FIG. 7 shows another example of a semi-static configuration, according to some embodiments.

FIG. 8 shows an example of application of ‘cell_index’ and ‘slot_offset’ configuration, according to some embodiments.

FIG. 9 show an example of a semi-static configuration, according to some embodiments.

FIG. 10 show an example of a semi-static configuration, according to some embodiments.

FIG. 11 show an example of a semi-static configuration, according to some embodiments.

FIG. 12 shows an example of a communication system 1200, according to some embodiments.

FIG. 13 shows a user equipment, according to some embodiments.

FIG. 14 shows a network node, according to some embodiments.

FIG. 15 is a block diagram of a host, according to some embodiments.

FIG. 16 is a block diagram illustrating a virtualization environment in which functions implemented by some embodiments may be virtualized, according to some embodiments.

FIG. 17 shows a communication diagram of a host communicating via a network node with a user equipment over a partially wireless connection, in accordance with some embodiments.

FIG. 18 shows a method of operating a wireless device, according to some embodiments.

FIG. 19 shows a method of operating a wireless device, according to some embodiments.

FIG. 20 shows a method of operating a network node, according to some embodiments.

FIG. 21 shows a method of operating a network node, according to some embodiments.

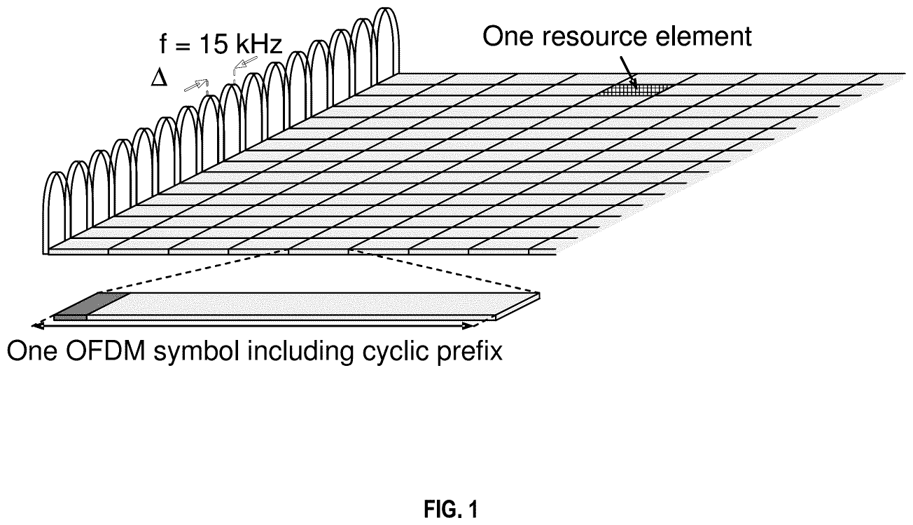

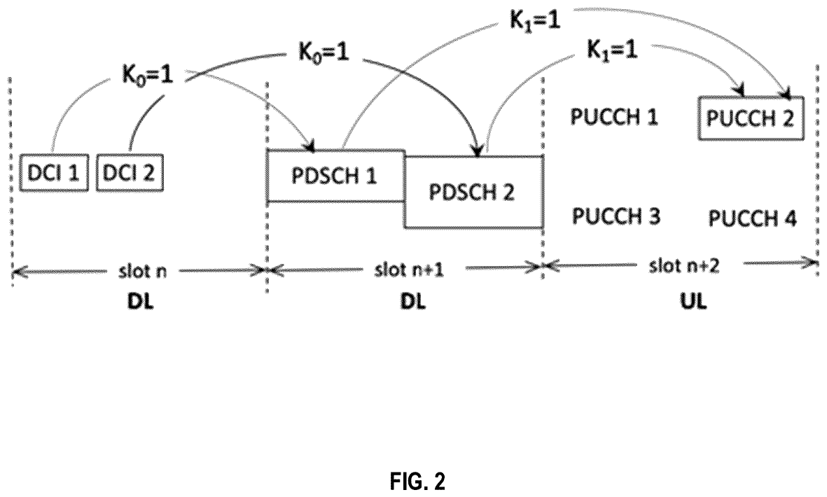

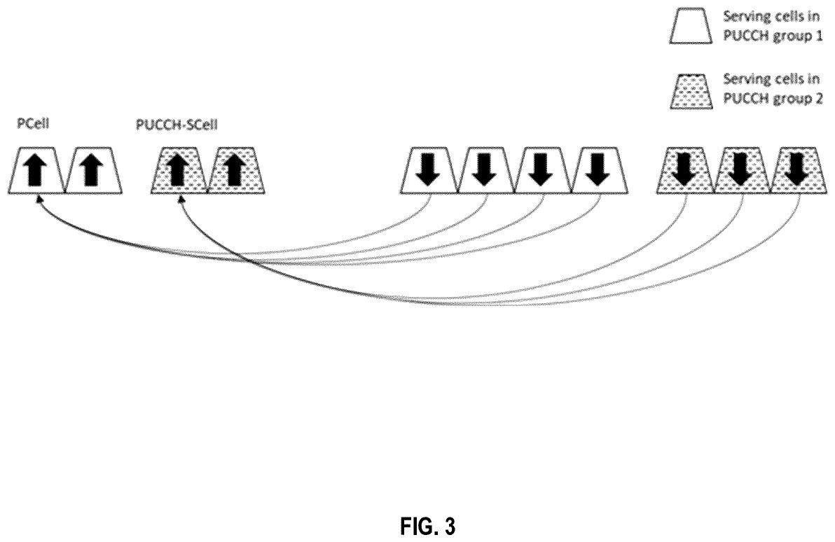

These figures will be best understood by reference to the following detailed description.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. These concepts and applications fall within the scope of the disclosure.

It has been proposed to solve this issue by allowing SPS HARQ-ACK which would otherwise be dropped to be deferred to a next available UL slot instead. Complete details to support the solution are still under discussion in 3GPP.

There currently exist certain challenge(s). The existing behavior of HARQ-ACK feedbacks is too restrictive in some scenarios, especially when the delay of HARQ-ACK transmission is of very high importance. For example, the PCell or PUCCH-SCell or the configured UL cell for HARQ-ACK may not have TDD pattern suitable for fast HARQ-ACK feedback, thus causing a delay bottleneck for the overall DL transmission. Allowing PUCCH carrier switching can then be useful to address such issue.

It is still not clear how to support PUCCH carrier switching in the specification, especially when SCS of different carriers are not the same.

Certain aspects of the disclosure and their embodiments may provide solutions to these or other challenges. The proposed solutions include different methods of semi-static pattern configuration for PUCCH carrier switching. Two main methods are based on:
configuration of (cell index, slot_offset) pair for each slot in a PCell or other reference cell
configuration of bitmap indicating cell index for each slot of the UL cell with highest SCS

The solutions also include methods for determining PDSCH-to-HARQ-ACK timing when PUCCH carrier switching is applied. For example, the indicated PDSCH-to-HARQ-ACK timing can be applied with respect to PCell or other configurable reference UL cell.

Certain embodiments may provide one or more of the following technical advantage(s). The proposed solutions provide a flexible configuration of PUCCH carrier switching where a cell index can be indicated for each slot. With the full support of PUCCH carrier switching, it can be useful, e.g., for URLLC, to reduce the overall DL transmission latency which involves HARQ retransmission.

Some proposed solutions can also provide an alternative method to enable SPS HARQ-ACK deferral when operating with a single PUCCH cell.

Some of the embodiments contemplated herein will now be described more fully with reference to the accompanying drawings. Embodiments are provided by way of example to convey the scope of the subject matter to those skilled in the art.

The following set of embodiments are described in general and can be applied to both slot-based PUCCH and sub-slot based PUCCH configuration. It applies to both HARQ-ACK feedback of dynamically scheduled PDSCH, and that of SPS PDSCH and SPS release.

The term “carrier” and “cell” are used with similar meanings in the context of this disclosure.

The methods and procedures are described under the assumption of a PUCCH group, which contains a primary cell (PCell) and one or more secondary cells for carrier aggregation. However, it is understood that the methods and procedures can be easily applied to other scenarios.
If a UE is configured with dual-connectivity operation, i.e., an MCG and a SCG, the UE can apply the same methods and procedures described below for both MCG and SCG. For example, the counterpart of the primary cell (i.e., PCell) in MCG there is the PSCell of SCG.
The UE may be configured with more than one PUCCH group, for example, two PUCCH groups. In this case, the methods and procedures described below can be equally applied in each PUCCH group. For example, if the UE is provided with two PUCCH groups (primary PUCCH group and secondary PUCCH group), then the counterpart of the primary cell is the PUCCH-SCell in the secondary PUCCH group.

A person skilled in the art may realize that other combining embodiments and/or variants are possible.

All relevant configurations regarding configured cells, resources, timing indicators, offsets, etc. may be indicated and/or transmitted by a gNB and may be received by a user equipment via configuration information (e.g., RRC configuration messages, DCI, and/or MAC CE).

### Semi-Static Configuration of PUCCH Cell Index and Slot Offset for PUCCH Carrier Switching

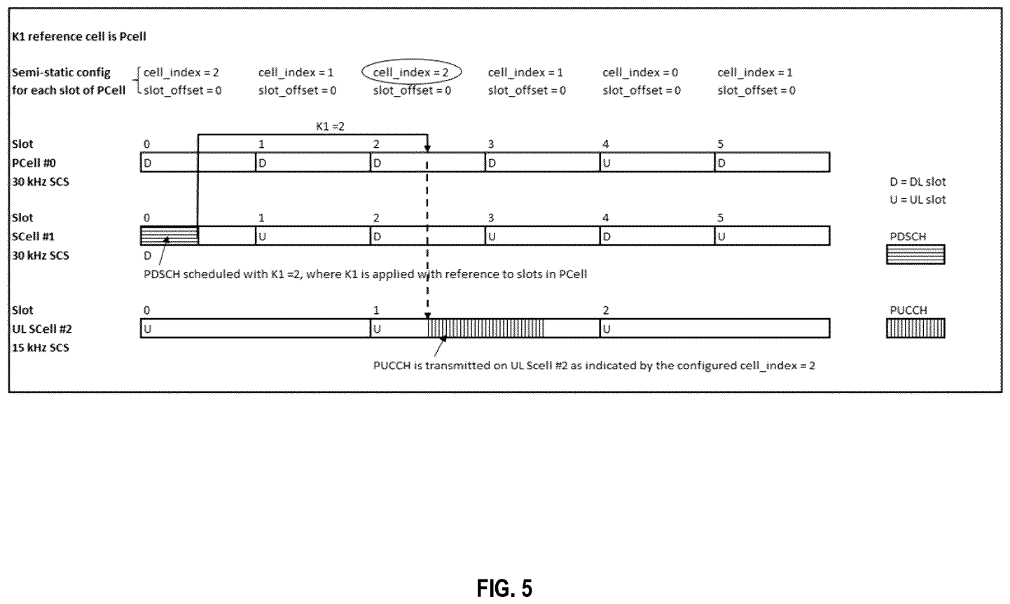

In one non-limiting embodiment, a pair of (‘cell_index’, ‘slot_offset’) is semi-statically configured for each slot in a reference cell of a PUCCH group, where ‘cell_index’ indicates the index of the UL cell in the PUCCH group to use for PUCCH transmission and ‘slot_offset’ indicates a slot (or sub-slot) offset with respect to the corresponding first slot in the indicated cell. As an alternative, the indexing of (sub-)slot and (sub-)slot offset is according to slot duration of the cell for PUCCH without carrier switching, i.e., Pcell/PScell/PUCCH-SCell in the same PUCCH group. FIGS. 5-9 show various examples of semi-static configuration of ‘cell_index’ and ‘slot_offset’ for each slot in a reference cell.

In one non-limiting embodiment, the UE determines PUCCH cell index in a PUCCH group and slot index to transmit PUCCH based on a pair of (‘cell_index’, ‘slot_offset’) and the PDSCH-to-HARQ_feedback timing indicator (K1), where K1 is received via PDCCH and applied with reference to slots in the reference cell of the PUCCH group (see FIGS. 5-11).

In one version of above embodiments, the reference cell of a PUCCH group can be semi-statically configured to the UE for each PUCCH group.

In another version of above embodiments, the reference cell of a PUCCH group is the primary cell of the PUCCH group.

FIG. 5 shows an example of a semi-static configuration of ‘cell_index’ and ‘slot_offset’ for each slot in a reference cell where the reference cell is, for example, PCell #0. Here, PDSCH is scheduled to be transmitted in slot #0 on SCell #1 with K1=2. Since K1 is applied with reference to the reference cell (PCell), the corresponding slot for PUCCH may be slot #2 on PCell. However, due to the configured cell_index value=2 for slot #2 in the PCell, the PUCCH may be transmitted on the SCell #2 in the corresponding slot, which may happen to be slot #1 in this case. Note that there may be a single slot in SCell #2 which corresponds to a slot in Pcell, so this one slot in SCell #2 will be used regardless of the slot_offset value.

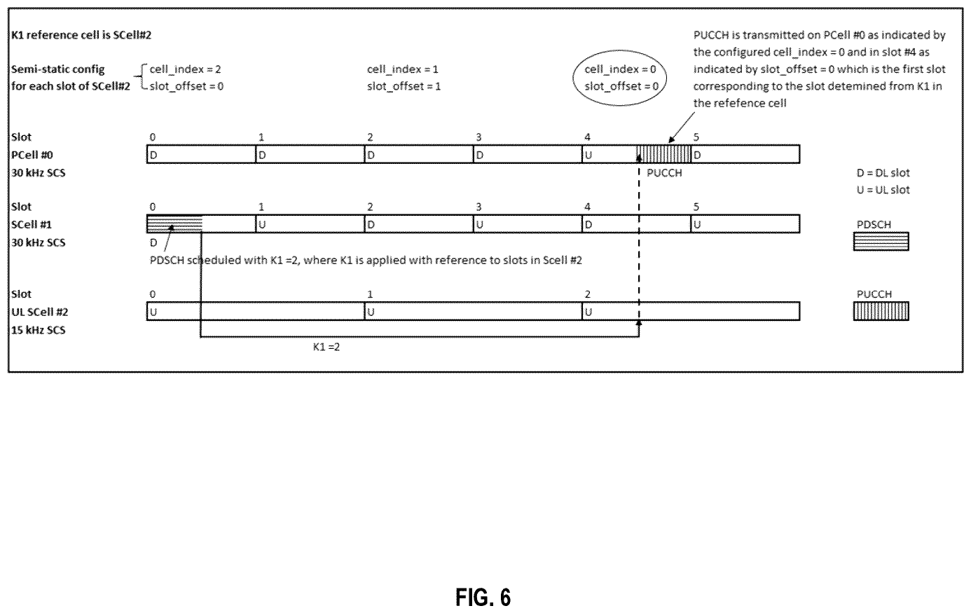

FIG. 6 shows an example of semi-static configuration of ‘cell_index’ and ‘slot_offset’ for each slot in a reference cell where the reference cell is, for example, SCell #2. Here PDSCH is scheduled to be transmitted in slot #0 on SCell #1 with K1=2. Since K1 is applied with reference to the reference cell (SCell #2), the corresponding slot for PUCCH would be slot #2 on SCell #2. However, due to the configured cell_index value=0 for slot #2 in the SCell #2, the PUCCH is transmitted on the PCell #0. Since there are two slots in PCell #0 which corresponds to a slot in SCell #2, the slot_offset value=0 indicates that the PUCCH is to be transmitted in the first slot corresponding to the slot determined from K1 in the reference cell (SCell #2). That is, in this case, the PUCCH is transmitted in slot #4 on PCell #0. In some aspects, the first slot of the indicated PUCCH cell which corresponds to the slot determined from K1 in the reference cell can be determined by Pucch_slot_cell_j=FLOOR [pucch_slot_of_reference_cell*(SCS_i/SCS_j)], where cell_i is the reference cell, and cell_j is the indicated PUCCH cell.

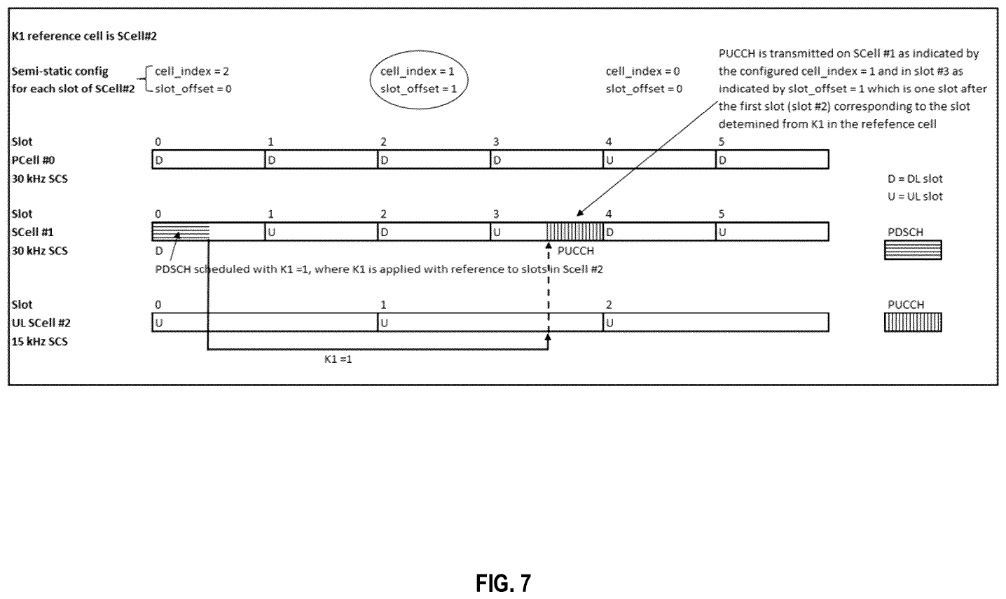

FIG. 7 shows an example of semi-static configuration of ‘cell_index’ and ‘slot_offset’ for each slot in a reference cell where the reference cell is, for example, SCell #2. Here PDSCH is scheduled to be transmitted in slot #0 on SCell #1 with K1=1. Since K1 is applied with reference to the reference cell (SCell #2), the corresponding slot for PUCCH would be slot #1 on SCell #2. However, due to the configured cell_index value=1 for slot #1 in the SCell #2, the PUCCH is transmitted on the SCell #1. Since there are two slots in SCell #1 which correspond to a slot in SCell #2, the slot_offset value=1 indicates that the PUCCH is to be transmitted in a slot which is one slot after the first slot corresponding to the slot determined from K1 in the reference cell (SCell #2). That is, in this case, the PUCCH is transmitted in slot #3 on SCell #1.

In one non-limiting embodiment, the configuration of (‘cell_index’, ‘slot_offset’) is applied periodically. That is, if it is configured for N slots, it is applied periodically to a set of N consecutive slots.

In one non-limiting embodiment, the configuration of (‘cell_index’, ‘slot_offset’) can only result in PUCCH being transmitted on at most one UL cell at a time.

In one non-limiting embodiment, the configuration of (‘cell_index’, ‘slot_offset’) can result in possible PUCCH transmissions on more than one UL cells. In this case, the UE determines the cell index to use for PUCCH transmission based on:
the order of the cell index
duplexing type of the cell,
whether the cell is an SUL cell

For example, if there are multiple possible cells (e.g., reference cell and at least one designated cell) to choose according to the configuration of (‘cell_index’, ‘slot_offset’), the UE chooses the cell with lowest (or, alternatively, highest) index, or with FDD cell first, or with SUL cell first.

In one non-limiting embodiment, the range of ‘slot_offset’ value is from 0 to N−1, where N is the ratio max_SCS/referenceCell_SCS.

In another embodiment, a bitmap is used for indicating ‘slot_offset’ where the number of bits needed for the bitmap equals the ratio, max_SCS/referenceCell_SCS.

In one non-limiting embodiment, the semi-static configuration of (‘cell_index’, ‘slot_offset’) to use for PUCCH carrier switching is only applicable to semi-static PUCCH transmission, e.g., PUCCH carrying SR, PUCCH carrying periodic/semi-persistent CSI, and PUCCH carrying SPS HARQ-ACK.

In one non-limiting embodiment, the semi-static configuration of (‘cell_index’, ‘slot_offset’) to use for PUCCH carrier switching is applicable to any PUCCH transmission.

In case that dynamic PUCCH carrier indicator is also used, different UE behaviors can be applied:
If the UE is capable of simultaneous PUCCH transmission on multiple cells,
   the UE transmits PUCCH in response to dynamic PDSCH on a cell indicated by the PUCCH carrier indicator and transmit, if any, other PUCCH on a cell indicated by the semi-static configuration of (‘cell_index’, ‘slot_offset’).
if the UE does not support simultaneous PUCCH transmission on multiple cells,
the UE transmits PUCCH only on a cell indicated by the dynamic PUCCH carrier indicator regardless of the semi-static configuration of (‘cell_index’, ‘slot_offset’)
   if there is other PUCCH, e.g., PUCCH carrying SR, to be transmitted at the same time, the UE can either
      drop the other PUCCH, or
      multiplex the other PUCCH (UCI of the other PUCCH) onto PUCCH on the cell indicated by the dynamic PUCCH carrier indicator.

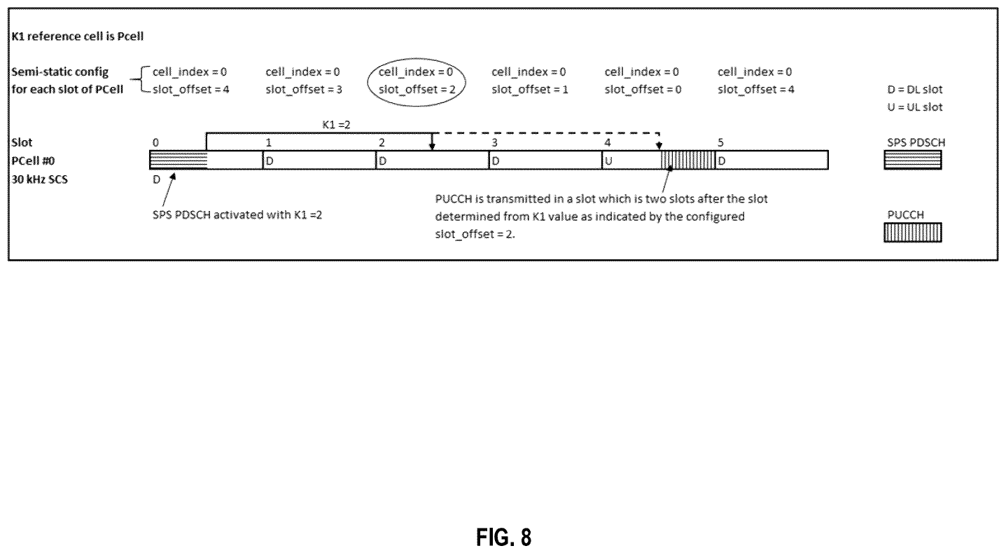

In one embodiment, in a single cell operation, the configuration ‘cell_index’ and ‘slot_offset’ are semi-statically configured for each slot, where ‘slot_offset’ indicates a slot offset with respect to the corresponding slot determined from K1. When applying to SPS HARQ-ACK, the configuration of ‘slot_offset’ can be used to enable SPS HARQ-ACK deferral where SPS HARQ-ACK which collides with invalid slot according to the K1 value in the activation DCI can be deferred to another slot by applying the slot offset value. See example in FIG. 8.

In one non-limiting embodiment, pucch-Cell configuration of PDSCH of a serving cell, includes one of more configured cell indexes for ‘cell_index’.

In one non-limiting embodiment, pucch-Config is considered for all the cells configured with ‘cell-index’.

FIG. 8 shows an example of application of ‘cell_index’ and ‘slot offset’ configuration to SPS HARQ-ACK deferral.

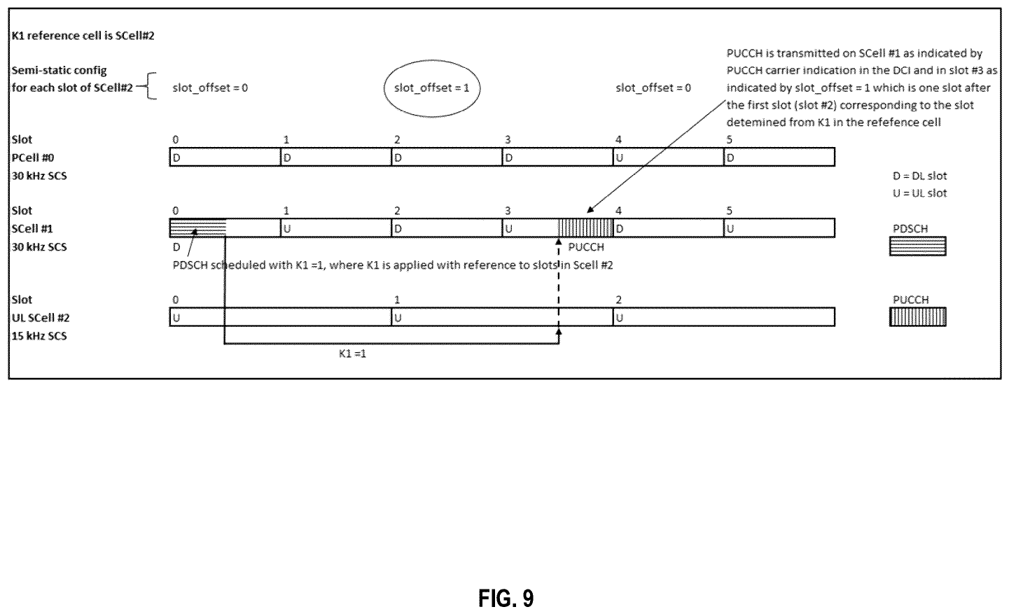

Note that in the above embodiments, the ‘cell_index’ may not be configured but indicated dynamically instead. In that case, the ‘slot_offset’ configuration is used to further indicate which slot in the indicated cell to use for PUCCH transmission. See FIG. 9 for an example.

FIG. 9 show an example of semi-static configuration of ‘slot_offset’ for each slot in a reference cell where the reference cell is, for example, SCell #2. Here PDSCH is scheduled to be transmitted in slot #0 on SCell #1 with K1=1. Since K1 is applied with reference to the reference cell (SCell #2), the corresponding slot for PUCCH would be slot #1 on SCell #2. In this example, PUCCH cell index is dynamically indicated to be SCell #1. Since there are two slots in SCell #1 which corresponds to a slot in SCell #2, the slot_offset value=1 indicates that the PUCCH is transmitted in a slot which is one slot after the first slot corresponding to the slot determined from K1 in the reference cell (SCell #2). That is, in this case, the PUCCH is transmitted in slot #3 on SCell #1.

### Semi-Static Configuration of Sequence Indicating PUCCH Cell Index for PUCCH Carrier Switching

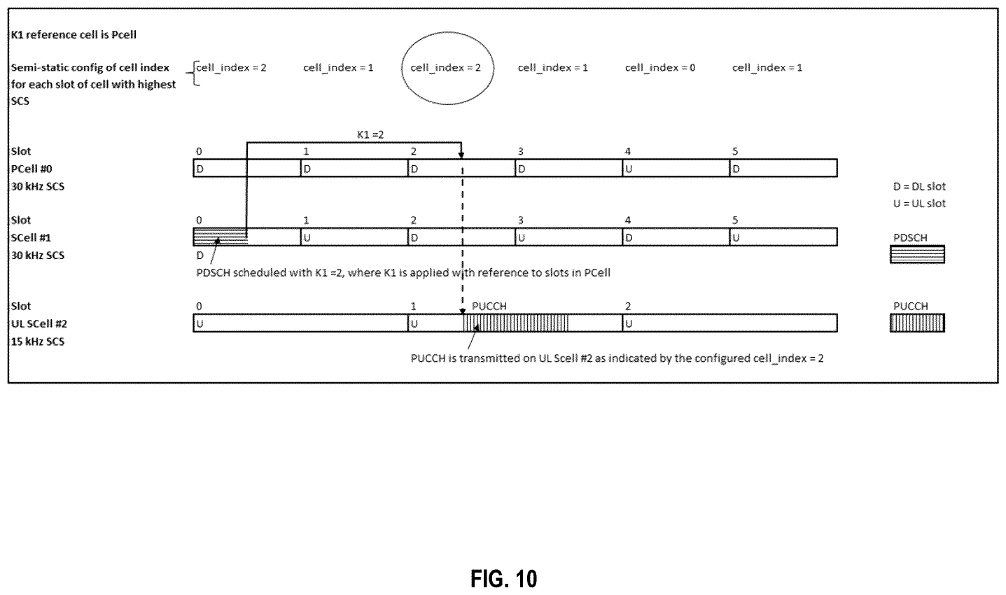

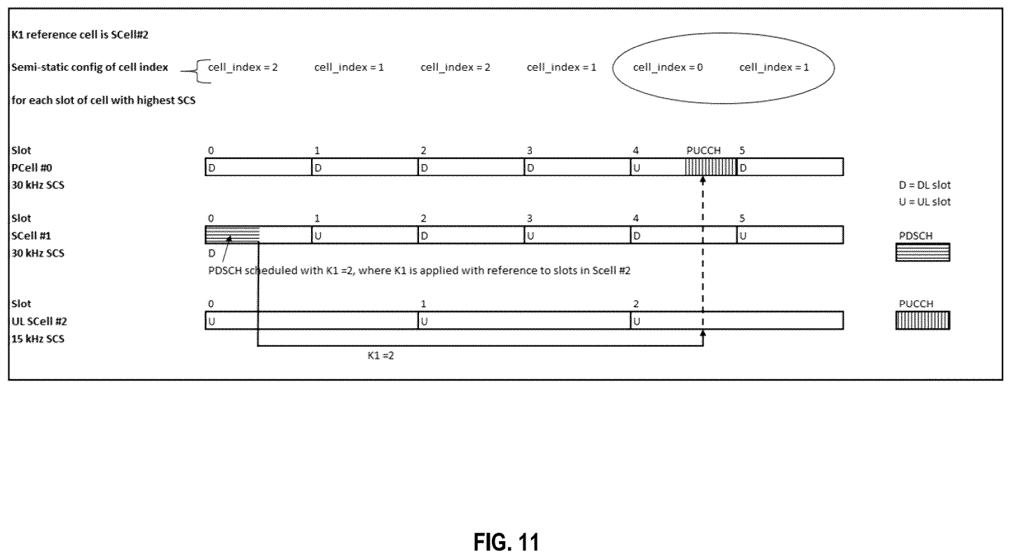

In one non-limiting embodiment, a sequence of cell indices is semi-statically configured for each slot with reference to a reference cell. See examples in FIGS. 10 and 11. Example cells to use as a reference cell include:
The cell with highest SCS in a PUCCH group; or
The cell with the lowest SCS in the PUCCH group; or
The reference cell of a PUCCH group is the primary cell of the PUCCH group, i.e., Pcell, PScell, or PUCCH-SCell; or
The reference cell of a PUCCH group can be semi-statically configured to the UE for each PUCCH group.

In one example, all switching-supported slots in the primary cell use the same sequence of cell indices. In another example, the switching-supported slots may use different sequence of cell indices. Here the switching-supported slots refer to the slots on the primary cell that allow PUCCH carrier switching, if needed. For a given PUCCH group, the sequence of cell indices can be defined using one or more of the methods below:
An ordered list of cell indices that is semi-statically configured;
An ordered list of cell indices who use the same SCS as the primary cell;
An ordered list of cell indices who use SCS that are the same or higher than the SCS of the primary cell;
An ordered list of cell indices who use SCS that are the same or lower than the SCS of the primary cell;
An ordered list of cell indices that belong to the same frequency range (FR) as the primary cell.
An ordered list of cell indices that belong to the frequency range (FR) lower than that of the primary cell. For example, if the primary cell is in FR2, then the list of cell indices for carrier switching contains cells in FR1 of the same PUCCH group, including SUL if configured.
An ordered list of cell indices that use a preferred duplex, i.e., only FDD cells in the PUCCH group.

In one example, the switching-supported slots may include one or more of the following on the carrier scheduled to transmit PUCCH, before applying carrier switching:
Full downlink slots only, i.e., a slot that contains DL symbols only;
mixed slots, i.e., a slot contains one or more symbols of either DL or flexible symbol, in addition to one or more of UL symbols;
flexible slots, i.e., a lot that contains flexible symbols only.

In the above, full uplink slot is not included as a switching-supported slot, since a full uplink slot is expected to be capable of supporting the PUCCH transmission, without any need to switch the PUCCH to another carrier. This is appropriate if PUCCH carrier switching is only used to find alternative PUCCH resources due to TDD UL/DL pattern. On the other hand, if PUCCH carrier switching is used to provide alternative PUCCH resources due to other reasons (e.g., a low priority PUCCH being deprioritized by a high priority uplink transmission), then the switching-supported slots may include full uplink slots also, so that a low-priority PUCCH is transmitted on another carrier, instead of being discarded, when collision occurs.

If a PUCCH is signaled to be transmitted in a switching-supported slot on the reference cell, but the PUCCH transmission is not possible due to insufficient uplink symbol for the PUCCH, then the PUCCH transmission is switched to the next cell on the sequence of cell indices which does provide sufficient number of uplink symbols for the PUCCH in the same. The switching to next cell can be via cyclically testing the next cell on the list until a cell capable of supporting the PUCCH is found. If no cell on the list can adequately support the PUCCH transmission (e.g., no cell on the list has sufficient number of uplink symbols in the slot), then the PUCCH may be dropped, or deferred to a subsequent slot.

The transmission direction (downlink, uplink, flexible) is determined according to an option below, or a combination of the options.
In a preferred embodiment, the transmission direction (downlink, uplink, flexible) is according to the semi-static RRC configuration only, i.e., the cell common configuration tdd-UL-DL-ConfigurationCommon and the UE specific TDD uplink-downlink configuration tdd-UL-DL-ConfigurationDedicated if configured.
In an alternative embodiment, the transmission direction takes into consideration of slot format indicators dynamically provided to the UE. For example, the slot format signaled by DCI format 2_0, when the UE is configured by higher layers with parameter SlotFormatIndicator.

In one non-limiting embodiment, the UE determines PUCCH cell index in a PUCCH group based on the sequence of cell indices and the PDSCH-to-HARQ_feedback timing indicator (K1), where K1 is applied with reference to slots in the reference cell of the PUCCH group.

FIG. 10 shows an example of semi-static configuration of sequence of cell indices for each slot of cell with highest SCS which in this case is slot with 30 kHz SCS. Here PDSCH is scheduled to be transmitted in slot #0 on SCell #1 with K1=2. Since K1 is applied with reference to the reference cell (PCell), the corresponding slot for PUCCH would be slot #2 on PCell. However, due to the configured cell_index value=2 for slot #2 in the PCell, the PUCCH is instead transmitted on the SCell #2 in the corresponding slot, which happens to be slot #1 in this case. Note that in this example there is only one slot in SCell #2 which corresponds to a slot in the PCell.

In one non-limiting embodiment, the configuration of cell index sequence is applied periodically. That is, if it is configured for N slots, it is applied periodically to a set of N consecutive slots.

In one non-limiting embodiment, if the configuration of cell index sequence results in possible PUCCH transmission on more than one UL cells, the UE determines the cell index to use for PUCCH transmission based on the first value configured for the corresponding slot. See an example in FIG. 11. FIG. 11 shows an example of semi-static configuration of sequence of cell indices for each slot of cell with highest SCS which in this case is slot with 30 kHz SCS. Here PDSCH is scheduled to be transmitted in slot #0 on SCell #1 with K1=2. Since K1 is applied with reference to the reference cell (SCell #2), the corresponding slot for PUCCH would be slot #2 on SCell #2. There are two cell index values (cell_index=0 and cell_index=1) corresponding to this slot #2 on SCell #2, implying that two possible PUCCH carriers are possible for the PUCCH transmission. In this case, the UE transmits PUCCH on PCell #0 following the first cell_index value of the two applicable values.

In another embodiment, if the configuration of cell index sequence results in possible PUCCH transmission on more than one UL cells, the UE determines the cell index to use for PUCCH transmission based on:
the order of the cell index
duplexing type of the cell,
   For example, a FDD cell is given priority for switched PUCCH transmission than a TDD cell, since each slot in a FDD cell is available for UL transmission, whereas a TDD cell can only have a subset of slots for UL transmission.
whether the cell is an SUL cell.
   For example, a SUL cell is given priority for switched PUCCH transmission than a regular UL cell, since the SUL cell tends to use lower carrier frequency and gives better link budget for PUCCH transmission.

In one non-limiting embodiment, the value in the sequence can be ‘N/A’ implying that no UL cell is configured for a particular slot.

### Other Alternative Embodiments Related to Switching

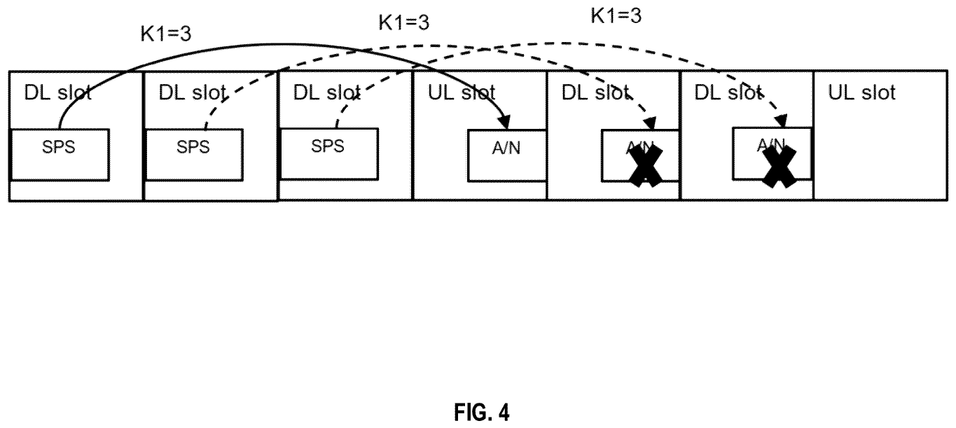

In one embodiment, instead of using pair (‘cell_index’, ‘slot_offset’) to indicate PUCCH cell switching, we use only K1 (based on primary PUCCH cell's slot size), and check where is the valid PUCCH available in all the cells (e.g., of different SCSs) where given that PUCCH is not available in primary cell. For example, in FIG. 4, we just mention K1=2, the PUCCH is available in cell #2, there we don't even need to mention (‘cell_index’, ‘slot_offset’). Further, if there are multiple scells with PUCCH availability, UE chooses the cell whose UL symbols available for PUCCH come earlier.

In one embodiment, if PUCCH switching is allowed, then K1 is measured always based on slots of the cell with largest SCS (smallest slot size granularity) instead of primary PUCCH cell slot size. If K1 points to multiple SCells with PUCCH availability, then the PUCCH which comes earlier is chosen first, or the PUCCH on the cell with the smallest cell index, or the PUCCH on the cell with the largest cell index is chosen.

In one embodiment, PUCCH carrier switching can be allowed for:
Specific SPS configuration IDs; for example, only the SPS of the lowest configuration IDs if multiple SPS has HARQ-ACK bits to be transmitted in the same uplink (sub-)slot.
Specific PHY priority PUCCH/UCI; for example, PUCCH carrier switching is supported for high PHY priority PUCCH transmission only.
One rule could be, if PUCCH is configured with repetitions, then if PUCCH is being switched to new SCell, then if in this SCell, the PUCCH resource is available but limited, i.e., not all PUCCH repetitions can be performed, then
   UE is still allowed to switch to this SCell for PUCCH transmission (for whatever repetitions),
   UE is not allowed to switch to this SCell for PUCCH transmission as this transmission will be under-reliable.
      Determination of Slot to Use for PUCCH when Operating with PUCCH Carrier Switching

When a UE is operating with PUCCH carrier switching, it can be dynamically indicated to transmit PUCCH on a specific carrier other than the default PUCCH carrier, i.e., a primary cell of the PUCCH cell group. If K1 is applied with reference to slots in the indicated PUCCH carrier, it is clear which slot in the indicated PUCCH carrier to use for PUCCH transmission.

However, if K1 is applied with reference to slots in the reference carrier which is not the same as the indicated PUCCH carrier, then there can be ambiguity on which slot in the indicated PUCCH carrier to use for PUCCH transmission. For example, when different UL carriers in a PUCCH group have different SCS and/or when the carriers do not have aligned frame boundaries, a slot in the reference carrier may correspond to more than one slots in the indicated carrier.

In one embodiment, an earliest valid slot in the indicated cell which corresponds to the slot in the reference cell is used for PUCCH transmission.
In the above embodiment, a first slot in the indicated cell corresponds to a second slot in the reference cell if the first slot overlaps in time with the second slot.
In another version, a first slot in the indicated cell corresponds to a second slot in the reference cell if the first slot overlaps in time with the second slot and does not start earlier than the second slot.
In the above embodiment, a valid slot can include an UL slot or a slot which contains sufficient valid symbols for UL transmission.

In one embodiment, a slot offset is dynamically indicated in the DCI scheduling PDSCH to use for determining a slot for PUCCH transmission in the indicated carrier.

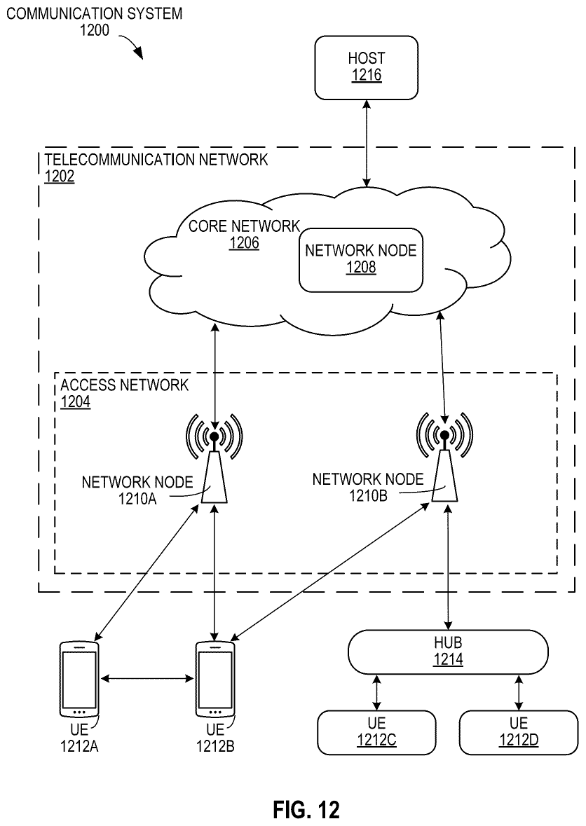

FIG. 12 shows an example of a communication system 1200 in accordance with some embodiments. In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3^{rd} Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

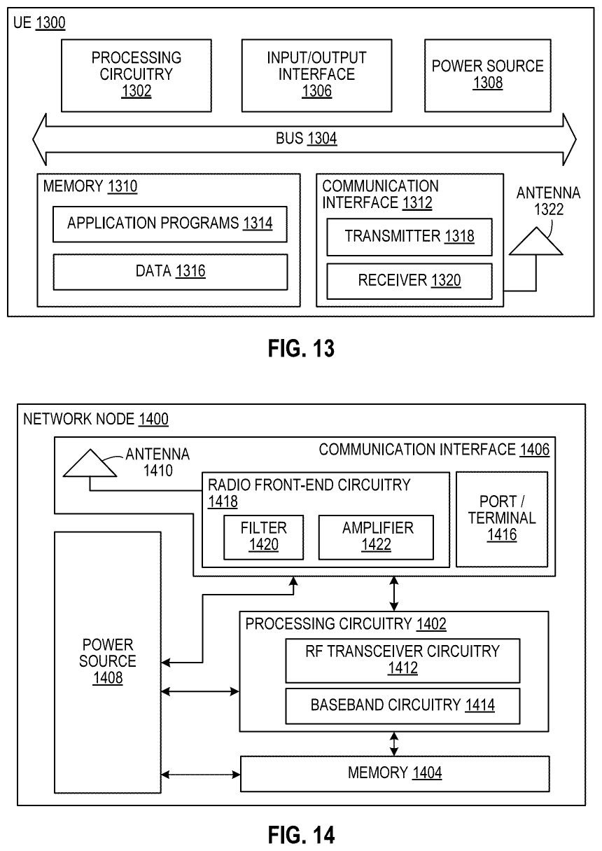

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (cMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

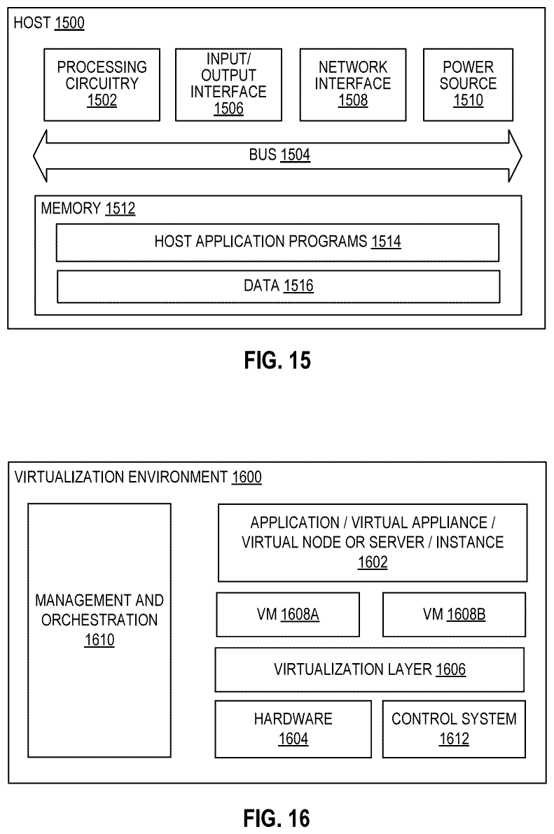

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

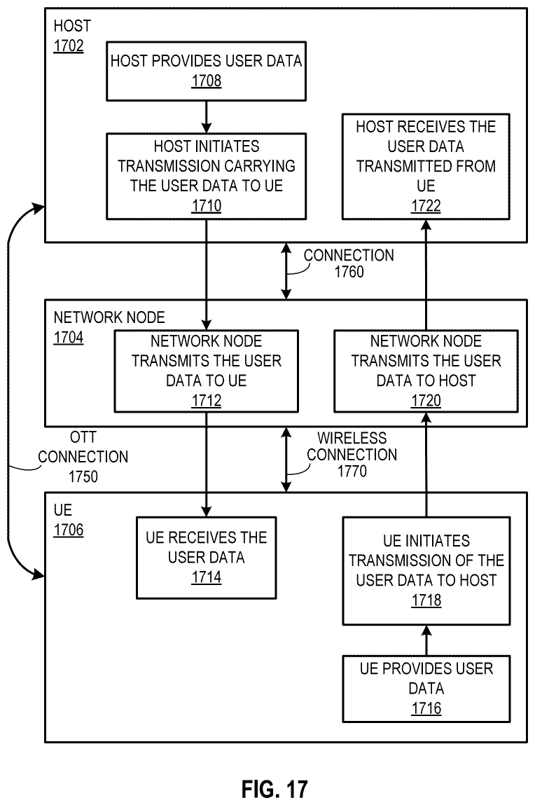

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may improve, for example, the data rate, latency, power consumption, or the like and thereby provide benefits such as reduced user waiting time, relaxed restriction on file size, improved content resolution, better responsiveness, extended battery lifetime, or the like.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

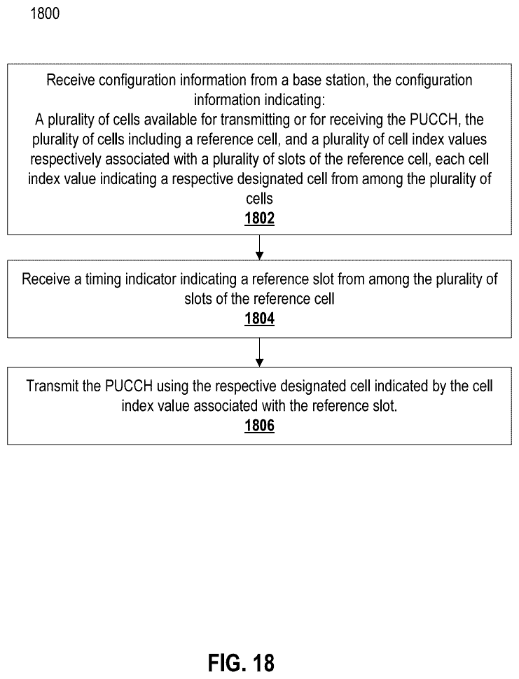

FIG. 18 is a flowchart of a method 1800 performed by embodiments of a UE 1212, 1300, and/or 1706 as described herein according to some embodiments. Embodiments of the method 1800 may begin at an operation 1802 in which the UE receives configuration information from a base station, such as embodiments of the network node 1210 or 1400 as described herein. The configuration information indicates a plurality of cells available for transmitting or for receiving the PUCCH, the plurality of cells including a reference cell. The configuration information further indicating a plurality of cell index values respectively associated with a plurality of slots of the reference cell, each cell index value indicating a respective designated cell from among the plurality of cells. The method 1800 includes an operation 1804, in which the UE receives a timing indicator indicating a reference slot from among the plurality of slots of the reference cell. The method 1800 includes an operation 1804, in which the UE transmits the PUCCH using the respective designated cell indicated by the cell index value associated with the reference slot. Other embodiments of the method 1800 may include additional operations and details as described herein.

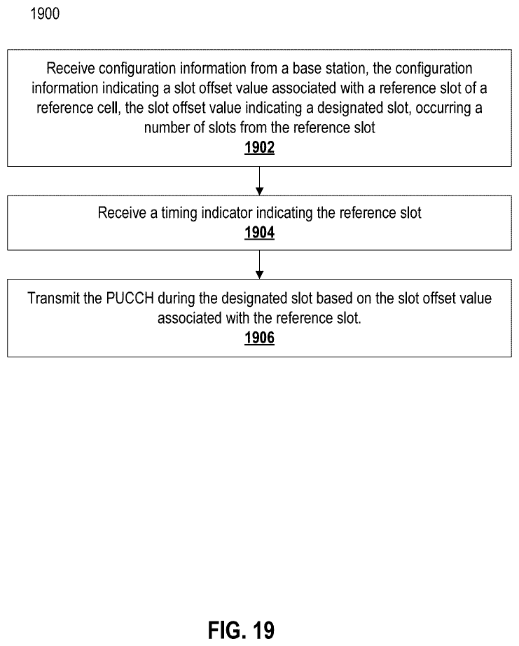

FIG. 19 is a flowchart of a method 1900 performed by embodiments of a UE 1212, 1300, and/or 1706 as described herein according to some embodiments. Embodiments of the method 1900 may begin at an operation 1902 in which the UE receives configuration information from a network node, such as embodiments of the network node 1210 or 1400 as described herein. The configuration information indicates a slot offset value associated with a reference slot of a reference cell, the slot offset value indicating a designated slot, occurring a number of slots from the reference slot. The method 1900 includes an operation 1904, in which the UE receives a timing indicator indicating the reference slot. The method 1900 includes an operation 1906, in which the UE transmits the PUCCH during the designated slot based on the slot offset value associated with the reference slot. Other embodiments of the method 1900 may include additional operations and details as described herein.

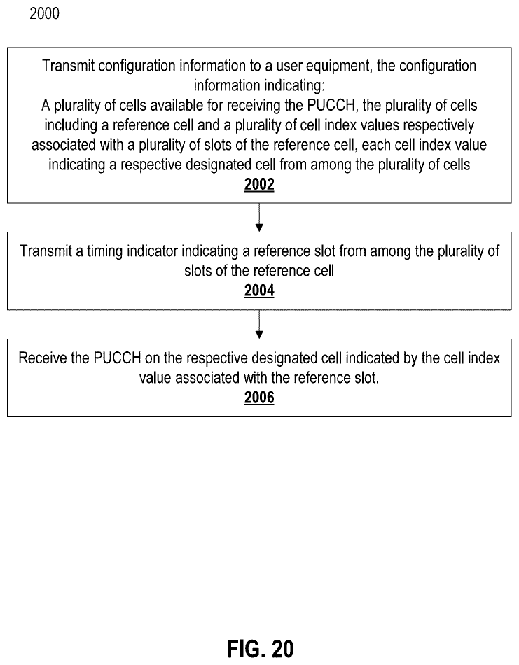

FIG. 20 is a flowchart of a method 2000 performed by embodiments of a network node 1210, 1400, and/or 1704 as described herein, according to some embodiments. Embodiments of the method 2000 may begin at an operation 2002, in which the network node transmits configuration information to a UE, such as embodiments of the UE 1212 or 1300, as described herein. The configuration information indicates a plurality of cells available for receiving the PUCCH, the plurality of cells including a reference cell and indicates a plurality of cell index values respectively associated with a plurality of slots of the reference cell, each cell index value indicating a respective designated cell from among the plurality of cells. The method 2000 includes an operation 2002, in which the network node transmits a timing indicator indicating a reference slot from among the plurality of slots of the reference cell. The method 2000 also includes an operation 2004, in which the network node receives the PUCCH on the respective designated cell indicated by the cell index value associated with the reference slot. Other embodiments of the method 2000 may include additional operations and details as described herein.

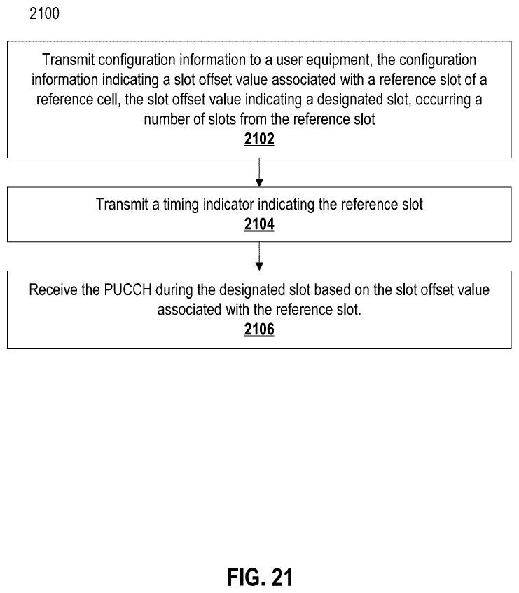

FIG. 21 is a flowchart of a method 2100 performed by embodiments of a network node 1210, 1400, and/or 1704 as described herein, according to some embodiments. Embodiments of the method 2100 may begin at an operation 2102, in which the network node transmits configuration information to a UE, such as embodiments of the UE 1212 or 1300, as described herein. The configuration information indicates a slot offset value associated with a reference slot of a reference cell, the slot offset value indicating a designated slot, occurring a number of slots from the reference slot. The method 2100 includes an operation 2104, in which the network node transmits a timing indicator indicating the reference slot. The method 2100 includes an operation 2106, in which the network node receives the PUCCH during the designated slot based on the slot offset value associated with the reference slot. Other embodiments of the method 2100 may include additional operations and details as described herein.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment for transmitting a physical uplink control channel, PUCCH, the method comprising:
receiving configuration information from a network node, the configuration information indicating:
a plurality of cells available for transmitting or for receiving the PUCCH, the plurality of cells including a reference cell; and
a plurality of cell index values respectively associated with a plurality of slots of the reference cell, each cell index value indicating a respective designated cell from among the plurality of cells;
receiving a timing indicator indicating a reference slot from among the plurality of slots of the reference cell; and
transmitting the PUCCH using the respective designated cell indicated by the cell index value associated with the reference slot.

2. The method of claim 1, wherein the timing indicator indicates the reference slot by indicating that the reference slot is a slot occurring a given number of slots from reception of a physical downlink shared channel.

3. The method of claim 1, wherein a cell index value indicates the reference cell as the respective designated cell.

4. The method of claim 1, where the receiving configuration information indicating the plurality of cell index values comprises dynamically receiving the configuration information indicating a cell index value.

5. The method of claim 1, wherein receiving the configuration information includes the configuration information indicating a slot offset value indicating a designated slot on the designated channel during which the PUCCH is to be transmitted.

6. The method of claim 1, wherein the timing indicator is received over a physical downlink control channel, PDCCH.

7. A method performed by a user equipment for transmitting physical uplink control channel, PUCCH, the method comprising:
receiving configuration information from a network node, the configuration information indicating a slot offset value associated with a reference slot of a reference cell, the slot offset value indicating a designated slot, occurring a number of slots from the reference slot;
receiving a timing indicator indicating the reference slot; and
transmitting the PUCCH during the designated slot based on the slot offset value associated with the reference slot.

8. The method of claim 7, wherein the slot offset value indicates that the reference cell is a designated cell.

9. The method of claim 7, further comprising:
providing user data; and
forwarding the user data to a host via transmission to the network node.

10. A method performed by a network node for receiving a physical uplink control channel, PUCCH, the method comprising:
transmitting configuration information to a user equipment, the configuration information indicating:
a plurality of cells available for receiving the PUCCH, the plurality of cells including a reference cell; and
a plurality of cell index values respectively associated with a plurality of slots of the reference cell, each cell index value indicating a respective designated cell from among the plurality of cells;
transmitting a timing indicator indicating a reference slot from among the plurality of slots of the reference cell; and
receiving the PUCCH on the respective designated cell indicated by the cell index value associated with the reference slot.

11. The method of claim 10, wherein the timing indicator indicates the reference slot by indicating that the reference slot is a slot occurring a given number of slots from transmission of a physical downlink shared channel.

12. The method of claim 11, wherein a cell index value indicates the reference cell as the respective designated cell.

13. The method of claim 11, where the transmitting configuration information indicating the plurality of cell index values includes dynamically transmitting the configuration information indicating a cell index value.

14. The method of claim 11, wherein transmitting the configuration information includes the configuration information indicating a slot offset value indicating a designated slot on the designated channel during which the PUCCH is to be received.

15. The method of claim 11, wherein the timing indicator is transmitted over a physical downlink control channel, PDCCH.

16. A method performed by a network node for receiving a physical uplink control channel, PUCCH, the method comprising:
transmitting configuration information to a user equipment, the configuration information indicating a slot offset value associated with a reference slot of a reference cell, the slot offset value indicating a designated slot, occurring a number of slots from the reference slot;
transmitting a timing indicator indicating the reference slot; and
receiving the PUCCH during the designated slot based on the slot offset value associated with the reference slot.

17. The method of claim 16, wherein the slot offset value indicates that the reference cell is a designated cell.

18. The method of claim 16, further comprising:
obtaining user data; and
forwarding the user data to a host or a user equipment.

19. A user equipment for transmitting a physical uplink control channel, PUCCH, comprising:
processing circuitry configured to perform any of the steps of claim 1; and
power supply circuitry configured to supply power to the processing circuitry.

20. A network node for receiving a physical uplink control channel, PUCCH, the network node comprising:
processing circuitry configured to perform any of the steps of claim 10; and
power supply circuitry configured to supply power to the processing circuitry.

21.-45. (canceled)
